(19) United States
(12) Patent Application Publication
(10) Pub. No.: US 2015/0186552 A1
(43) Pub. Date: Jul. 2, 2015

(54) RETRIEVING INDEXED VIDEO AND TEXT CONTENT USING CONTEXT EXTRACTED FROM INCOMING IMAGES

(71) Applicant: International Business Machines Corporation, Armonk, NY (US)

(72) Inventors: Arup Acharya, Nanuet, NY (US); Kirk Alan Beaty, Goldens Bridge, NY (US); Ajay Ashok Deshpande, White Plains, NY (US); Justin Gregory Manweiler, Somers, NY (US); Shachi Sharma, Dehli (IN)

(73) Assignee: INTERNATIONAL BUSINESS MACHINES CORPORATION, Armonk, NY (US)

(21) Appl. No.: 14/145,982

(22) Filed: Jan. 1, 2014

(51) Int. Cl. G06F 17/30; H04L 29/06

(52) U.S. Cl. CPC G06F 17/30979; H04L 65/60

(57) ABSTRACT

Content from a technical library is retrieved by associating a SIP URI and a HTTP URI with each one of a plurality of existing entries in a technical library maintained by an autonomous computer-based technical assistant. The SIP URI is used on a computing system in communication with the technical assistant across a computer network to communicate a visual image of a device from a user of that device to the technical assistant. The communicated visual image is used to construct a three-dimensional model of the device, which is then used to identify at least one existing entry in the technical library maintained. Each identified existing entry contains technical data associated with the user device. The HTTP URI associated with the identified existing entry in the technical library is used to display the technical data on the computing system associated with the user.

### FIELD OF THE INVENTION

The present invention relates to technical support systems.

### BACKGROUND OF THE INVENTION

Repairing and assembling computers, appliances and complex machinery requires a technician to conduct a manual search of repair manuals or other documentation for instructions on how to conduct a given repair and the parts necessary for that repair. This requires identifying both the specific part of a given object or machine for which additional information is required and the location within a given manual where the relevant information is found. This is an inefficient and time-consuming process.

### SUMMARY OF THE INVENTION

Systems and methods in accordance with the present invention eliminate the need for a technician or user of a given device to manually identify parts to be repaired/assembled and portions of a repair/assembly manual relevant to the repair/assembly of those parts. An automated system is provided that determines the necessary technical information from visual images of a given device communicated from the user to an autonomous technical assistant having an existing database of technical data for a plurality of different device. A session initiation protocol (SIP) uniform resource indicator (URI) is maintained for each device as is a web-site, i.e., a hypertext transfer protocol (HTTP) URI. SIP is a commonly used protocol for audio and visual communications across a network. When a visual image of the device, such as a live video containing any part of the associated device is sent to a SIP URI associated with the device or that class of devices, the web site associated with the devices website displays technical data such as pages from the repair manual that contain information about the device. Therefore, a technician or user does not have to search a manual to look up pages as that process is automated based on the video stream content.

### BRIEF DESCRIPTION OF THE DRAWINGS

FIG. 1 is a schematic representation illustrating an embodiment of a system for obtaining technical information from a database in accordance with the present invention; and

FIG. 2 is a flow chart illustrating an embodiment of a method for obtaining technical information from a database in accordance with the present invention.

### DETAILED DESCRIPTION

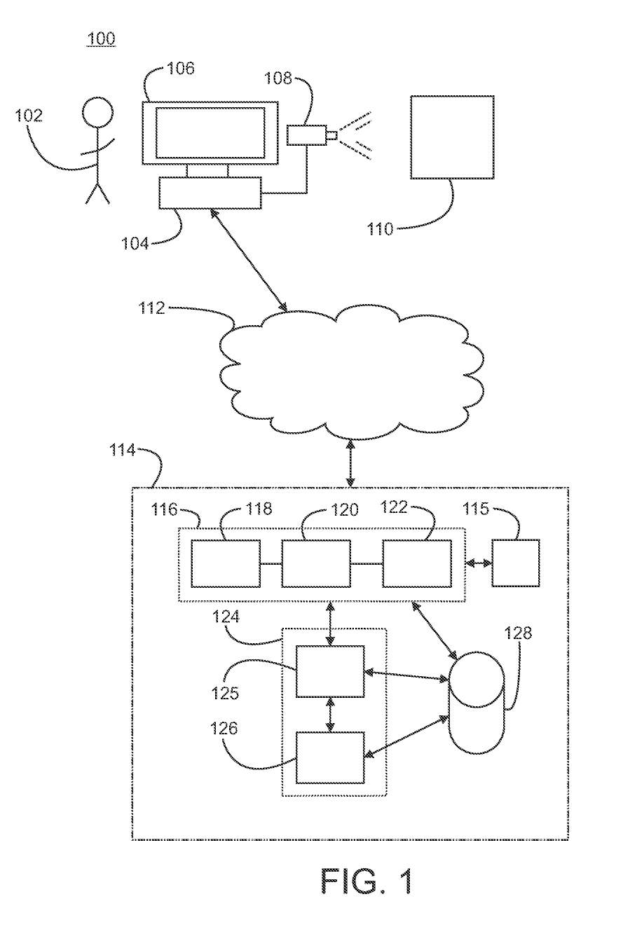

Referring initially to FIG. 1, exemplary embodiments in accordance with the present invention are directed to a system for providing content from a technical library 100. The system is used to provide technical support to a user 102, i.e., an end-user or technician, that is working on a given device 110. These devices include, but are not limited to, any devices that may require service, repair, maintenance, assembly, or upgrade work such as automobiles, trucks, motorcycles, bicycles, appliances, military vehicles, weapons systems, farm equipment, power tools, heating and air-conditioning systems, computer equipment and medical equipment. These devices typically have various technical data associated with them to assist in maintenance, assembly and repair. The technical data include parts lists, instruction manuals, assembly instructions, repair manuals, technical bulletins, pictures and instructional videos. The technical data can be generated or maintained by the manufacturer of the device or can be generated by a third party, such as an aftermarket parts supplier, a third party publisher of service manuals, web blogs, and user-generated instructional videos posted on the Internet.

All of this technical data is helpful to the user in diagnosis of a problem, identifying any required parts and performing the required repairs. In addition, it may used to identify what step in an assembly process the user has completed and thereby present guidance on the next step or identify a missed step based on an image of what has been constructed and what parts are remain to be assembled. The system of the present invention stores the technical data and makes in available to the user of the device in response to visual images of the device communicated from the user to the system. The system utilizes a computing system 104 that is associated with the user 102. Suitable computing systems are known and available in the art and include, but are not limited to personal computers, desktop computers, laptop computers, netbooks, table computers, cellular phones including smartphones and combinations thereof. In general, the computing system includes connectivity to one or more computer networks 112.

This connectivity is used to transmit visual images of the device 110 and to receive technical information relevant to that device. Suitable visual images include, but are not limited to, a photograph of the user device or a video image of the user device. When the user is actively engaged in working on or repairing the user device, the visual image is a real-time streaming video image of the user device. In order to obtain and transmit these visual images of the user device, the system includes at least one image capture device 108 in communication with or incorporated into the computing system 104. Suitable image capture devices include still cameras, video cameras and webcams. In one embodiment, the image capture device is a web-cam incorporated into a smartphone or tablet computer. Alternatively, the image capture device is a hands-free camera that is worn by the user, for example on a headband or incorporated into a pair of glasses or safety goggles. Therefore, the user can transmit images of the user device that the user is currently viewing as the user is working on the device. Alternatively, the visual image of the device is obtained from a camera or device separate form the computing system, and a computer-readable file is uploaded to the computing system. The computer system can also include scanners or telefacsimile capabilities for entering sketches, photographs and other printed materials.

In order to display any of the technical information provided to the user, the system includes at least one visual display 106 in communication with the computing system 104. In one embodiment, the computing system is further configured to use a hypertext transfer protocol uniform resource indicator associated with identified existing entries in a technical library to display technical data on the visual display that are relevant to the maintenance and repair of the user device.

The system includes technical assistant 114 configured as an autonomous computer-based system in communication with the computing system 104 across the computer network 112. The autonomous computer-based system can be network enabled computer or a server. In addition, the technical assistance can be configured as a distributed computing system. The various functionalities of the technical assistant are embodiment in hardware and software modules within the autonomous computer-based system. These software modules are software applications executing within the autonomous computer-based system.

The technical assistant includes a database 128 containing a technical library with a plurality of existing entries. Each existing entry in the technical library includes the technical data associated with one given device. Preferably the technical library includes technical data associated with a plurality of different devices. Each existing entry has data associated with an entire given device, e.g., a complete manual, or a portion of a given device, e.g., a diagram of a sub-assembly a chart of a memory system. Suitable technical data include, but are not limited to, repair manuals, instructional videos, additional visual images, repair instructions, operational instructions, identifications of components and combinations thereof. The database also includes a plurality of existing structural features associated with the existing entries. Each existing structural feature is a complete representation, i.e., visual or schematic representation, of the existing structural feature. These existing structural features are used in feature matching and model generation. In one embodiment, the database stores the software code embodying the various functions and modules of the technical assistant.

In one embodiment, a session initiation protocol based (SIP) uniform resource indicator (URI) and a separate hypertext transfer protocol (HTTP) URI are associated each existing entry in the technical library is stored in the database. These URIs are generated by the technical assistant and associated with different devices. The SIP URI is communicated to users, for example, published on a website or as part of a computer or smartphone application, and is used to establish a connection with the technical assistant to communicate the visual image. In one embodiment, the SIP URI link is encoded on a machine-readable barcode that is provided on the user device or on packaging or literature associated with the user device. A common SIP URI or HTTP URI can be associated with all device entries. Alternatively, a unique URI can be used for each device for which an entry exists in the technical library. In one embodiment, the URIs are assigned based on the class or category of device, e.g., engines, computers, machinery. Therefore, using a given SIP URI limits the categories of existing entries that are used in provided technical assistance to the user. The SIP URI is used to communicate the visual image of the user device to the technical assistant, and the HTTP URI is used to display the appropriate technical data to the user.

The technical assistant includes a communication module 115 to communicated across the network with computing systems associated with users needed technical assistance. The communication module receives the visual image of a user device communicated from the computing system across the computer network to the technical assistant. In addition, the communication module communicates the technical data relevant to a given user device back to the computing system associated with the user. The communication module is also used to communicate a given SIP based URI to the computing system so that the computing system can use the given session initiation protocol based uniform resource indicator to communicate the visual image of the user device.

The technical assistant includes a modeling module 116 configured to use the communicated visual image to construct a three-dimensional model of the user device. This modeling module includes an analyzer module 118 to analyze the communicated visual image and to extract structural features from the communicated visual image. Each extracted structural feature is a two-dimensional representation of at least a portion of the user device. The extracted structural feature can be the entire device. A comparison module 120 is included to match each extracted structural feature to one of the plurality of existing structural features stored in the database. The existing structural features are complete representations of the structural features and can be two-dimensional or three dimensional representations. An alignment module 122 is provided to use a position of each extracted structural feature within the communicated visual image to establish an alignment among all complete representations of all matched existing structural features to construct the three-dimensional model of the device. Therefore, known structural features related to the features displayed in the communicated visual image of the user device are arranged to match the alignments in the communicated visual image. This yields a complete three dimensional model of the user device.

The generated complete three-dimensional model can then be used to identify the user device as an known existing device or as closely related to a known existing device for which technical information is stored in the database. Therefore, the technical assistant includes a search module 124 that uses the constructed three-dimensional model as input to identify at least one existing entry in the technical library stored in the database 128 such that the existing entry is associated with the user device. In one embodiment, this search module includes a part or device recognition module 125 that recognizes parts of the generated three-dimensional model of the entire three-dimensional model as a portion of an existing device or an entire existing device for which technical information exists. Then a look-up and retrieval module 126 is used to obtain the relevant existing entries from the technical library for communication to the user and for display on the display device associated with the user.

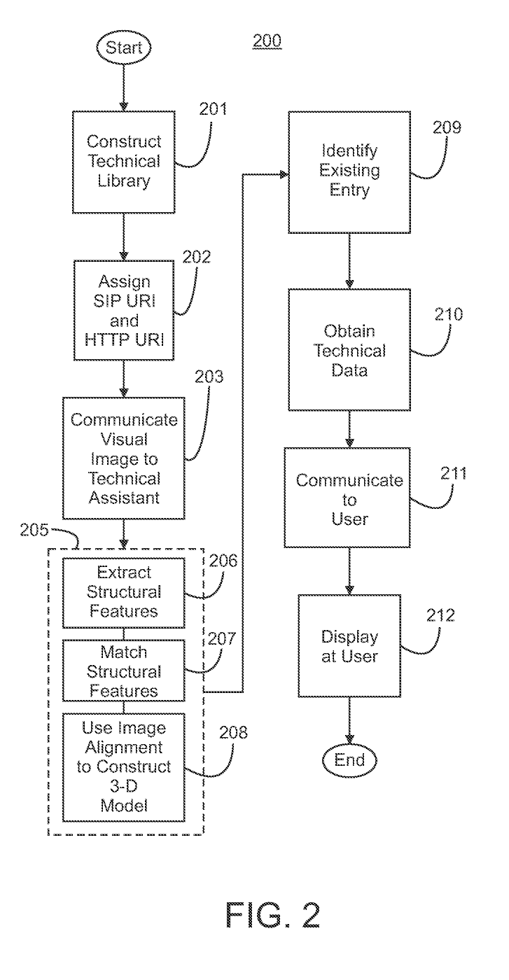

Referring to FIG. 2, exemplary embodiments in accordance with the present invention are also direct to a method for retrieving content from a technical library 200. Initially, a technical library is constructed 201 for at least one and preferably a plurality of existing devices. Each existing device has at least one existing entry in the technical library, and each existing entry includes technical data for its associated device. A SIP URI and a separate HTTP URI is associated with each existing entry in the technical library constructed and maintained by the technical assistant 202. These SIP URIs are provided to users 203 to use in obtaining technical data about a given device or class of devices.

A user of a user device obtains a visual image of the user device and communicates the visual image of the user device from a user of the device to a technical assistant 204, which is an autonomous computer-based system in communication with the computing system across a computer network. This includes communicating a photograph of the device or communicating a video image of the device. Preferably, a real-time streaming video image of the device is communicated to the technical assistant. In one embodiment, a computing system associated with the user is used to communicate the visual image to the autonomous computer-based system via the session initiation protocol based uniform resource indicator to communicate the visual image of the device.

The communicated visual image is used to construct a three-dimensional model of the device 205. Construction of the three-dimensional model includes extracting structural features from the communicated visual image 206. Each extracted structural feature is a two-dimensional representation of at least a portion of the user device. Each extracted structural feature is matched to an existing structural feature 207 that is a complete representation of an existing or known device or a portion of subcomponent of an existing device. These complete representations are stored at the technical assistant. A position of each extracted structural feature within the communicated visual image to establish an alignment among all complete representations of all matched existing structural features to construct the three-dimensional model of the device 208.

The constructed three-dimensional model is used at the technical assistant to identify at least one existing entry in a technical library maintained by the technical assistant 209. Each identified existing entry contains technical data associated with either one of or both the entire user device or a portion of the user device. Suitable technical data include, but are not limited to, repair manuals, instructional videos, additional visual images, repair instructions, operational instructions, identifications of components and combinations thereof. The associated technical data from the existing entry are obtained 210 and are communicated across one or more networks to the user 211. A visual display at the user and associated with the user computing system are user to display 212 the communicated technical data. In one embodiment, the hypertext transfer protocol uniform resource indicator associated with the identified existing entry in the technical library to display the technical data on the computing system associated with the user, for example, in an existing web browser. All of the desired technical data are obtained without the user having to request specific information or to search for specific technical information. The relevant technical data can be provided at different levels of specificity, from general information to information about a specific part or repair. The mange being capture can be used to determine the level of detail desire in the technical data, the exact repair or procedure being conducted or a specific part or grouping of parts for which technical data re desired. For example, if the communicated visual image is of the battery area of an engine compartment, then technical data relevant to battery repairs or electrical repairs for a given type of battery and make and model of automobile are communicated to the user.

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Methods and systems in accordance with exemplary embodiments of the present invention can take the form of an entirely hardware embodiment, an entirely software embodiment or an embodiment containing both hardware and software elements. In a preferred embodiment, the invention is implemented in software, which includes but is not limited to firmware, resident software and microcode. In addition, exemplary methods and systems can take the form of a computer program product accessible from a computer-usable or computer-readable medium providing program code for use by or in connection with a computer, logical processing unit or any instruction execution system. For the purposes of this description, a computer-usable or computer-readable medium can be any apparatus that can contain, store, communicate, propagate, or transport the program for use by or in connection with the instruction execution system, apparatus, or device. Suitable computer-usable or computer readable mediums include, but are not limited to, electronic, magnetic, optical, electromagnetic, infrared, or semiconductor systems (or apparatuses or devices) or propagation mediums. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Suitable data processing systems for storing and/or executing program code include, but are not limited to, at least one processor coupled directly or indirectly to memory elements through a system bus. The memory elements include local memory employed during actual execution of the program code, bulk storage, and cache memories, which provide temporary storage of at least some program code in order to reduce the number of times code must be retrieved from bulk storage during execution. Input/output or I/O devices, including but not limited to keyboards, displays and pointing devices, can be coupled to the system either directly or through intervening I/O controllers. Exemplary embodiments of the methods and systems in accordance with the present invention also include network adapters coupled to the system to enable the data processing system to become coupled to other data processing systems or remote printers or storage devices through intervening private or public networks. Suitable currently available types of network adapters include, but are not limited to, modems, cable modems, DSL modems, Ethernet cards and combinations thereof.

In one embodiment, the present invention is directed to a machine-readable or computer-readable medium containing a machine-executable or computer-executable code that when read by a machine or computer causes the machine or computer to perform a method for retrieving content from a technical library in accordance with exemplary embodiments of the present invention and to the computer-executable code itself. The machine-readable or computer-readable code can be any type of code or language capable of being read and executed by the machine or computer and can be expressed in any suitable language or syntax known and available in the art including machine languages, assembler languages, higher level languages, object oriented languages and scripting languages. The computer-executable code can be stored on any suitable storage medium or database, including databases disposed within, in communication with and accessible by computer networks utilized by systems in accordance with the present invention and can be executed on any suitable hardware platform as are known and available in the art including the control systems used to control the presentations of the present invention.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s) and steps or elements from methods in accordance with the present invention can be executed or performed in any suitable order. Therefore, it will be understood that the appended claims are intended to cover all such modifications and embodiments, which would come within the spirit and scope of the present invention.

What is claimed is:

1. A method for retrieving content from a technical library, the method comprising:
communicating a visual image of a device from a user of the device to a technical assistant;
using the communicated visual image to construct a three-dimensional model of the device; and
using the constructed three-dimensional model at the technical assistant to identify at least one existing entry in a technical library maintained by the technical assistant, each identified existing entry comprising technical data associated with at least one of the device and a portion of the device.

2. The method of claim 1, wherein communicating the visual image comprises communicating a photograph of the device or communicating a video image of the device.

3. The method of claim 1, wherein communicating the visual image comprises communicating a real-time streaming video image of the device.

4. The method of claim 1, wherein:
communicating the visual image comprises using a computing system associated with the user to communicate the visual image; and
the technical assistant comprises an autonomous computer-based system in communication with the computing system across a computer network.

5. The method of claim 1, wherein using the communicated visual image further comprises:
extracting structural features from the communicated visual image, each extracted structural feature comprising a two-dimensional representation of at least a portion of the device; and
matching each extracted structural feature to an existing structural feature comprising a complete representation stored at the technical assistant.

6. The method of claim 5, wherein using the communicated visual image further comprises using a position of each extracted structural feature within the communicated visual image to establish an alignment among all complete representations of all matched existing structural features to construct the three-dimensional model of the device.

7. The method of claim 1, the method further comprising associating a session initiation protocol based uniform resource indicator and a separate hypertext transfer protocol uniform resource indicator with each existing entry in the technical library maintained by the technical assistant.

8. The method of claim 7, wherein communicating the visual image of the device further comprises using the session initiation protocol based uniform resource indicator to communicate the visual image of the device.

9. The method of claim 7, wherein the method further comprises using the hypertext transfer protocol uniform resource indicator associated with the identified existing entry in the technical library to display the technical data on a computing system associated with the user.

10. The method of claim 1, wherein the technical data comprise repair manuals, instructional videos, additional visual images, repair instructions, operational instructions, identifications of components or combinations thereof.

11. A method for retrieving content from a technical library, the method comprising:
associating a session initiation protocol based uniform resource indicator and a separate hypertext transfer protocol uniform resource indicator with each one of a plurality of existing entries in a technical library maintained by a technical assistant comprising an autonomous computer-based system;
using the session initial protocol based uniform resource indicator on a computing system in communication with the technical assistant across a computer network to communicate a visual image of a device from a user of the device that is associated with the computing system to the technical assistant;
using the communicated visual image to construct a three-dimensional model of the device;
using the constructed three-dimensional model at the technical assistant to identify at least one existing entry in a technical library maintained by the technical assistant, each identified existing entry comprising technical data associated with at least one of the device and a portion of the device; and
using the hypertext transfer protocol uniform resource indicator associated with the identified existing entry in the technical library to display the technical data on the computing system associated with the user.

12. The method of claim 11, wherein using the communicated visual image further comprises:
extracting structural features from the communicated visual image, each extracted structural feature comprising a two-dimensional representation of at least a portion of the device;
matching each extracted structural feature to an existing structural feature comprising a complete representation stored at the technical assistant; and
using a position of each extracted structural feature within the communicated visual image to establish an alignment among all complete representations of all matched existing structural features to construct the three-dimensional model of the device.

13. The method of claim 11, wherein the visual image comprises a real-time streaming video image of the device.

14. The method claim 11, wherein the technical data comprise repair manuals, instructional videos, additional visual images, repair instructions, operational instructions, identifications of components or combinations thereof.

15. A computer-readable storage medium containing a computer-readable code that when read by a computer causes the computer to perform a method for retrieving content from a technical library, the method comprising:
communicating a visual image of a device from a user of the device to a technical assistant;
using the communicated visual image to construct a three-dimensional model of the device; and
using the constructed three-dimensional model at the technical assistant to identify at least one existing entry in a technical library maintained by the technical assistant, each identified existing entry comprising technical data associated with at least one of the device and a portion of the device.

16. The computer-readable storage medium of claim 15, wherein communicating the visual image comprises communicating a real-time streaming video image of the device.

17. The computer-readable medium of claim 15, wherein:
communicating the visual image comprises using a computing system associated with the user to communicate the visual image; and
the technical assistant comprises an autonomous computer-based system in communication with the computing system across a computer network.

18. The computer-readable medium of claim 15, wherein using the communicated visual image further comprises:
extracting structural features from the communicated visual image, each extracted structural feature comprising a two-dimensional representation of at least a portion of the device; and
matching each extracted structural feature to an existing structural feature comprising a complete representation stored at the technical assistant.

19. The computer-readable medium of claim 18, wherein using the communicated visual image further comprises using a position of each extracted structural feature within the communicated visual image to establish an alignment among all complete representations of all matched existing structural features to construct the three-dimensional model of the device.

20. The computer-readable medium of claim 15, wherein:
the method further comprises associating a session initiation protocol based uniform resource indicator and a separate hypertext transfer protocol uniform resource indicator with each existing entry in the technical library maintained by the technical assistant;
communicating the visual image of the device further comprises using the session initiation protocol based uniform resource indicator to communicate the visual image of the device; and
using the hypertext transfer protocol uniform resource indicator associated with the identified existing entry in the technical library to display the technical data on a computing system associated with the user.

21. A system for providing content from a technical library, the system comprising:
a computing system associated with a user;
an autonomous computer-based system in communication with the computing system across a computer network, the autonomous computer-based system comprising a technical assistant comprising:
a database comprising a technical library comprising a plurality of existing entries, each existing entry comprising technical data associated with at least one of a given device or a portion of a given device;
a communication module configured to receive a visual image of a user device communicated from the computing system across the computer network to the technical assistant;
a modeling module configured to use the communicated visual image to construct a three-dimensional model of the user device; and
a search module configured to use the constructed three-dimensional model to identify at least one existing entry in the technical library associated with the user device.

22. The system of claim 21, wherein the visual image comprises a photograph of the user device or a video image of the user device.

23. The system of claim 21, wherein the visual image comprises a real-time streaming video image of the user device.

24. The system of claim 21, wherein the computing system associated with the user further comprises an image capture device.

25. The system of claim 21, wherein:
the database further comprises a plurality of existing structural features associated with the existing entries, each existing structural feature comprising a complete representation of the existing structural feature; and
the modeling module further comprises:
an analyzer module to analyze the communicated visual image and to extract structural features from the communicated visual image, each extracted structural feature comprising a two-dimensional representation of at least a portion of the user device; and
a comparison module to match each extracted structural feature to one of the plurality of existing structural features.

26. The system of claim 25, wherein the modeling module further comprises an alignment module to use a position of each extracted structural feature within the communicated visual image to establish an alignment among all complete representations of all matched existing structural features to construct the three-dimensional model of the device.

27. The system of claim 21, wherein the database further comprises a session initiation protocol based uniform resource indicator and a separate hypertext transfer protocol uniform resource indicator associated each existing entry in the technical library.

28. The system of claim 27, wherein:
the communication module is configured to communicate a given session initiation protocol based uniform resource indicator to the computing system; and
the computing system is configured to use the given session initiation protocol based uniform resource indicator to communicate the visual image of the user device.

29. The system of claim 27, wherein:
the computing system comprises a visual display; and
the computing system is further configured to use the hypertext transfer protocol uniform resource indicator associated with the identified existing entry in the technical library to display the technical data on the visual display.

30. The method of claim 21, wherein the technical data comprise repair manuals, instructional videos, additional visual images, repair instructions, operational instructions, identifications of components or combinations thereof.
